(19) United States
(12) Patent Application Publication
(10) Pub. No.: US 2022/0326039 A1
(43) Pub. Date: Oct. 13, 2022

(54) METHOD, INFORMATION PROCESSING DEVICE, AND NON-TRANSITORY STORAGE MEDIUM

(71) Applicant: TOYOTA JIDOSHA KABUSHIKI KAISHA, Toyota-shi (JP)

(72) Inventors: Kodai TAKANOHASHI, Okazaki-shi (JP); Atsushi OKUBO, Nisshin-shi (JP); Yuji TACHIBANA, Nisshin-shi (JP); Shogo MOMOSHIMA, Nagoya-shi (JP); Takaaki KATO, Saitama-shi (JP); Daiki KANEICHI, Tokyo (JP); Minoru NAKADORI, Toyota-shi (JP)

(21) Appl. No.: 17/658,161

(22) Filed: Apr. 6, 2022

(30) Foreign Application Priority Data
Apr. 8, 2021 (JP) 2021-065860

(51) Int. Cl. G01C 21/36

(52) U.S. Cl. CPC G01C 21/3691

(57) ABSTRACT

A method executed by an information processing device includes acquiring a score indicating a driving skill of a user who drives a vehicle and executing traffic assistance processing based on the score at the time when the vehicle is parked. An information processing device comprises a controller that acquires a score indicating a driving skill of a user who drives a vehicle, and executes traffic assistance processing based on the score, at a time when the vehicle is parked. A non-transitory storage medium stores instructions that are executable by one or more processors and causes the one or more processors to acquire a score indicating a driving skill of a user who drives a vehicle, and execute traffic assistance processing based on the score, at a time when the vehicle is parked.

### CROSS-REFERENCE TO RELATED APPLICATION

This application claims priority to Japanese Patent Application No. 2021-065860 filed on Apr. 8, 2021, incorporated herein by reference in its entirety.

### BACKGROUND

### 1. Technical Field

The present disclosure relates to a method, an information processing device, and a non-transitory storage medium.

### 2. Description of Related Art

For example, technology is known for assisting traffic at the time when a vehicle, such as an automobile is parked. For example, Japanese Unexamined Patent Application Publication No. 2020-083301 (JP 2020-083301 A) discloses that light indicating a travel trajectory of a moving body is projected from the moving body onto a road surface at the time when the moving body is parked in a parking space.

### SUMMARY

Technology improvement is desired for assisting traffic at the time when a vehicle is parked.

The present disclosure provides technology for assisting traffic at the time when a vehicle is parked.

A first aspect of the present disclosure relates to a method executed by an information processing device including acquiring a score indicating a driving skill of a user who drives a vehicle and executing traffic assistance processing based on the score, at the time when the vehicle is parked.

In the method according to the first aspect, the traffic assistance processing may include first traffic assistance processing of displaying a course guide of the vehicle on a road surface by using a display device at the time when the user parks the vehicle. The course guide may be displayed in a first mode when the score is equal to or higher than a threshold value, and the course guide may be displayed in a second mode, in which the course guide is displayed more conspicuous than in the first mode, when the score is less than the threshold value.

In the method according to the first aspect, the traffic assistance processing may include second traffic assistance processing of displaying a peripheral area of the vehicle on a road surface by using a display device in a visually recognizable manner. The peripheral area of the vehicle may be displayed in a first mode when the score is equal to or higher than a threshold value, and the peripheral area of the vehicle may be displayed in a second mode, in which the peripheral area is displayed more conspicuous than in the first mode, when the score is less than the threshold value.

In the method according to the first aspect may further include determining whether or not a person or another vehicle is present in the vicinity of the vehicle. In the method, the information processing device may execute the second traffic assistance processing when the information processing device determines that the person or the other vehicle is present in the vicinity of the vehicle.

In the method according to the first aspect may further include specifying a first parking space where the vehicle is to be parked by the user, acquiring a first parking difficulty level of the first parking space as a threshold value, and specifying a second parking space having a second parking difficulty level which is lower than the first parking difficulty level of the first parking space, when the score is less than the threshold value. In the method, the information processing device may execute, as the traffic assistance processing, third traffic assistance processing of notifying the user of information for encouraging the user to park the vehicle in the second parking space instead of the first parking space, when the score is less than the threshold value.

In the method according to the first aspect may further include specifying a first parking space where the vehicle is to be parked by the user and acquiring a parking difficulty level of the first parking space for each of a plurality of parking methods used for the first parking space. In the method, the information processing device may execute, as the traffic assistance processing, fourth traffic assistance processing of notifying the user of the parking method in which the parking difficulty level is less than the score among the parking methods used for the first parking space.

In the method according to the first aspect, when two or more parking methods in which the parking difficulty level is less than the score exist, the user may be notified of one parking method in which the parking difficulty level is the highest among the two or more parking methods.

A second aspect of the present disclosure relates to an information processing device. The information processing device includes a controller. The controller may acquire a score indicating a driving skill of a user who drives a vehicle and execute traffic assistance processing based on the score, at the time when the vehicle is parked.

In the information processing device according to the second aspect, the traffic assistance processing may include first traffic assistance processing of displaying a course guide of the vehicle on a road surface by using a display device at the time when the user parks the vehicle. The controller may display the course guide in a first mode when the score is equal to or higher than a threshold value and display the course guide in a second mode, in which the course guide is displayed more conspicuous than in the first mode, when the score is less than the threshold value.

In the information processing device according to the second aspect, the traffic assistance processing may include second traffic assistance processing of displaying a peripheral area of the vehicle on a road surface by using a display device in a visually recognizable manner. The controller may display the peripheral area of the vehicle in a first mode when the score is equal to or higher than a threshold value and display the peripheral area of the vehicle in a second mode, in which the peripheral area is displayed more conspicuous than in the first mode, when the score is less than the threshold value.

In the information processing device according to the second aspect, the controller may determine whether or not a person or another vehicle is present in the vicinity of the vehicle and execute the second traffic assistance processing when the controller determines that the person or the other vehicle is present in the vicinity of the vehicle.

In the information processing device according to the second aspect, the controller may specify a first parking space where the vehicle is to be parked by the user and acquire a first parking difficulty level of the first parking space as a threshold value. The controller may specify a second parking space having a second parking difficulty level which is lower than the first parking difficulty level of the first parking space, when the score is less than the threshold value. The controller may execute, as the traffic assistance processing, third traffic assistance processing of notifying the user of information for encouraging the user to park the vehicle in the second parking space instead of the first parking space, when the score is less than the threshold value.

In the information processing device according to the second aspect, the controller may specify a first parking space where the vehicle is to be parked by the user and acquire a parking difficulty level of the first parking space for each of a plurality of parking methods used for the first parking space. The controller may execute, as the traffic assistance processing, fourth traffic assistance processing of notifying the user of the parking method in which the parking difficulty level is less than the score among the parking methods used for the first parking space.

In the information processing device according to the second aspect, when two or more parking methods in which the parking difficulty level is less than the score exist, the user may be notified of one parking method in which the parking difficulty level is the highest among the two or more parking methods.

A third aspect of the present disclosure relates to a non-transitory storage medium storing a program. The non-transitory storage medium storing the program that stores instructions that are executable by one or more processors and that cause the one or more processors to perform functions. The function performed by the one or more processors includes acquiring a score indicating a driving skill of a user who drives a vehicle and executing traffic assistance processing based on the score, at the time when the vehicle is parked.

In the storage medium according to the third aspect, the traffic assistance processing may include first traffic assistance processing of displaying a course guide of the vehicle on a road surface by using a display device at the time when the user parks the vehicle. The one or more processors may display the course guide in a first mode when the score is equal to or higher than a threshold value and display the course guide in a second mode, in which the course guide is displayed more conspicuous than in the first mode, when the score is less than the threshold value.

In the storage medium according to the third aspect, the traffic assistance processing may include second traffic assistance processing of displaying a peripheral area of the vehicle on a road surface by using a display device in a visually recognizable manner. The one or more processors may display the peripheral area of the vehicle in a first mode when the score is equal to or higher than a threshold value and display the peripheral area of the vehicle in a second mode, in which the peripheral area is displayed more conspicuous than in the first mode, when the score is less than the threshold value.

In the storage medium according to the third aspect, the function may further include determining whether or not a person or another vehicle is present in the vicinity of the vehicle. The one or more processors may execute the second traffic assistance processing when the information processing device determines that the person or the other vehicle is present in the vicinity of the vehicle.

In the storage medium according to the third aspect, the function may further include specifying a first parking space where the vehicle is to be parked by the user, acquiring a first parking difficulty level of the first parking space as a threshold value, and specifying a second parking space having a second parking difficulty level which is lower than the first parking difficulty level of the first parking space, when the score is less than the threshold value. The one or more processors may execute, as the traffic assistance processing, third traffic assistance processing of notifying the user of information for encouraging the user to park the vehicle in the second parking space instead of the first parking space, when the score is less than the threshold value.

In the storage medium according to the third aspect, the function may further include specifying a first parking space where the vehicle is to be parked by the user and acquiring a parking difficulty level of the first parking space for each of a plurality of parking methods used for the first parking space. The one or more processors may execute, as the traffic assistance processing, fourth traffic assistance processing of notifying the user of the parking method in which the parking difficulty level is less than the score among the parking methods used for the first parking space.

According to each aspect of the present disclosure, it is possible to improve technology for assisting traffic at the time when a vehicle is parked.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment of the present disclosure;

FIG. 2 is a block diagram showing a schematic configuration of a vehicle;

FIG. 3 is a block diagram showing a schematic configuration of a display device;

FIG. 4 is a block diagram showing a schematic configuration of an information processing device;

FIG. 5 is a flowchart showing an operation of the information processing device;

FIG. 6 is a flowchart showing an operation of the information processing device that executes first traffic assistance processing;

FIG. 7 is a diagram showing a specific example of traffic assistance by the first traffic assistance processing;

FIG. 8 is a flowchart showing an operation of the information processing device that executes second traffic assistance processing;

FIG. 9 is a diagram showing a specific example of traffic assistance by the second traffic assistance processing;

FIG. 10 is a flowchart showing an operation of the information processing device that executes third traffic assistance processing;

FIG. 11 is a diagram showing a specific example of traffic assistance by the third traffic assistance processing;

FIG. 12 is a flowchart showing an operation of the information processing device that executes fourth traffic assistance processing; and

FIG. 13 is a diagram showing a specific example of traffic assistance by the fourth traffic assistance processing.

### DETAILED DESCRIPTION OF EMBODIMENTS

Hereinafter, an embodiment of the present disclosure will be described.

### Overview of Embodiment

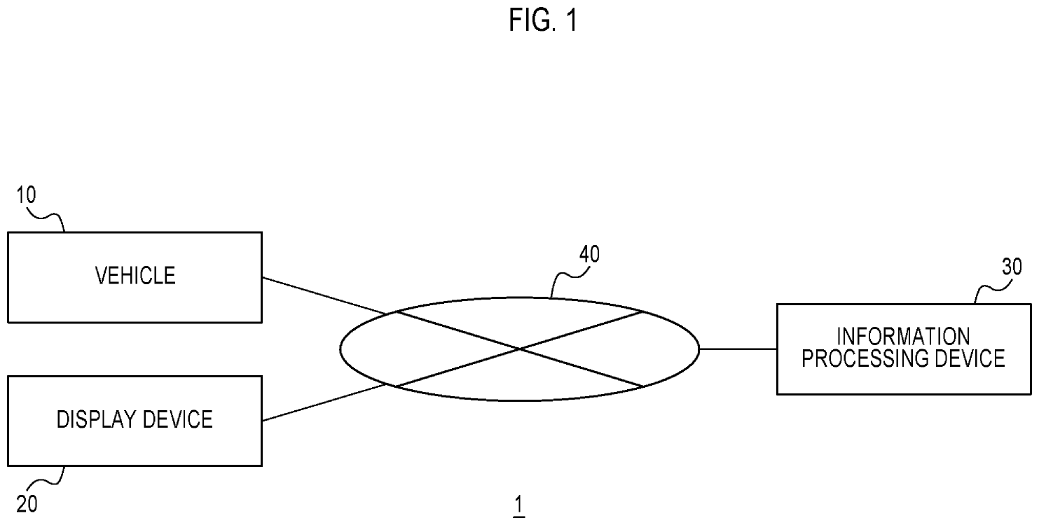

An overview of a system 1 according to an embodiment of the present disclosure will be described with reference to FIG. 1. The system 1 includes a vehicle 10, a display device 20, and an information processing device 30.

The vehicle 10 is, for example, an automobile but is not limited to this and may be any vehicle on which a human can board. In the present embodiment, the vehicle 10 is driven by a driver. The vehicle 10 may be capable of being remotely driven by the driver.

The display device 20 is a device for displaying an image on a road surface. As will be described later, for example, a lighting device embedded in the road surface, a projecting device provided so as to irradiate the road surface with light, or the like can be employed as the display device 20. In the present embodiment, the display device 20 is provided in a parking lot, for example, and capable of displaying an image on the road surface in response to an instruction from the information processing device 30 at the time when the vehicle 10 is parked.

The information processing device 30 is one or a plurality of computers capable of communicating with each other. The information processing device 30 is capable of communicating with each of the vehicle 10 and the display device 20 via, for example, a network 40 including a mobile communication network and the Internet. For example, the information processing device 30 is capable of displaying a designated image at a designated position on the road surface by communicating with the display device 20. The information processing device 30 is capable of acquiring vehicle information of the vehicle 10 by intermittently communicating with the vehicle 10. The vehicle information includes, for example, information such as a position and orientation of the vehicle 10, a camera video mounted on the vehicle 10, and a driving operation but is not limited to these and may include any information related to the vehicle 10.

First, the overview of the present embodiment will be described, and the details will be described later. The information processing device 30 acquires a score indicating a driving skill of a user who drives the vehicle 10. Thereafter, the information processing device 30 executes traffic assistance processing at the time when the vehicle 10 is parked based on the score.

As described above, according to the present embodiment, the technology for assisting traffic at the time when a vehicle is parked is improved in that the traffic assistance processing can be executed according to a driving skill of a user who drives the vehicle 10. The specific contents of the traffic assistance processing will be described later.

Next, each configuration of the system 1 will be described in detail.

Configuration of Vehicle

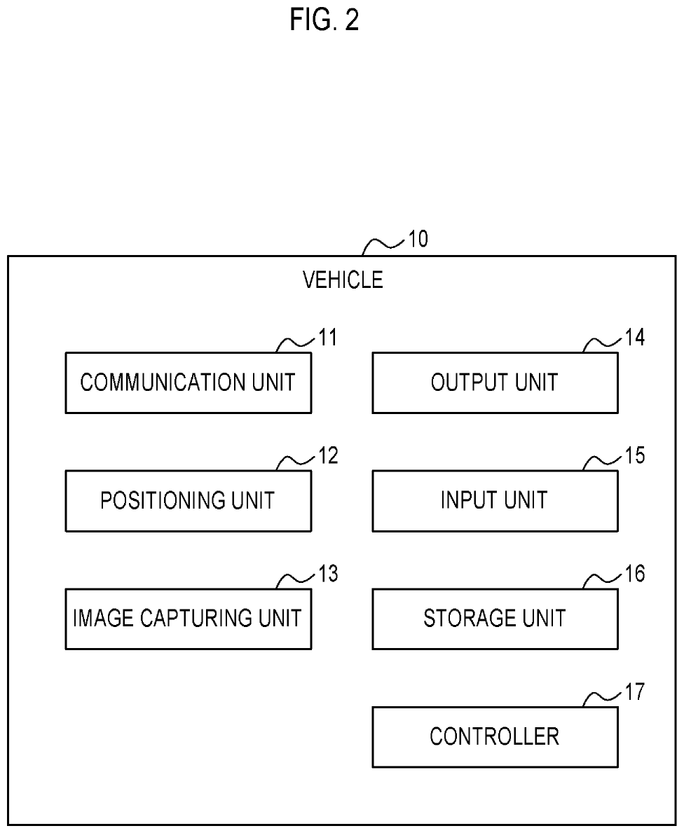

As shown in FIG. 2, the vehicle 10 includes a communication unit 11, a positioning unit 12, an image capturing unit 13, an output unit 14, an input unit 15, a storage unit 16, and a controller 17.

The communication unit 11 includes one or more communication interfaces connected to the network 40. The communication interface corresponds to a mobile communication standard, such as 4th generation (4G) or 5th generation (5G) but is not limited to these.

The positioning unit 12 includes one or more devices that acquire position information of the vehicle 10. Specifically, the positioning unit 12 includes, for example, a receiver corresponding to GPS but is not limited to this and may include a receiver corresponding to any satellite positioning system.

The image capturing unit 13 includes one or more cameras. Each camera included in the image capturing unit 13 may be provided in the vehicle 10 so as to be able to capture an image of a subject outside or inside the vehicle, for example. In the present embodiment, the image capturing unit 13 includes a front camera capable of capturing an image of a subject in front of the vehicle 10 and a rear camera capable of capturing an image of a subject behind the vehicle 10. Alternatively, the image capturing unit 13 may include an omnidirectional camera capable of capturing an image of a subject in the vicinity of the vehicle 10.

The output unit 14 may include one or more output devices that output information and notify the user of the information. Examples of the output device include a display that outputs information as a video and a speaker that outputs information as an audio, but the output device is not limited to these. The output unit 14 may include an interface for connecting an external output device.

The input unit 15 may include one or more input devices that detect a user input. Examples of the input device include a physical key, a capacitance key, a touch screen integrally provided with a display, or a microphone that receives a voice input, but the input device is not limited to these. The input unit 15 may include an interface for connecting an external input device.

The storage unit 16 includes one or more memories. Examples of the memory include a semiconductor memory, a magnetic memory, and an optical memory, but the memory is not limited to these. Each memory included in the storage unit 16 may function as, for example, a main storage device, an auxiliary storage device, or a cache memory. The storage unit 16 stores any information used for an operation of the vehicle 10. For example, the storage unit 16 may store a system program, an application program, or embedded software. The information stored in the storage unit 16 may be capable of updating with information acquired from the network 40 via, for example, the communication unit 11.

The controller 17 includes one or more processors, one or more programmable circuits, one or more dedicated circuits, or a combination thereof. The processor is, for example, a general-purpose processor, such as a central processing unit (CPU) or a graphics processing unit (GPU), or a dedicated processor specialized for a specific process, but is not limited to these. The programmable circuit is, for example, a field-programmable gate array (FPGA), but is not limited to this. The dedicated circuit is, for example, an application specific integrated circuit (ASIC), but is not limited to this. The controller 17 controls the operation of the entire vehicle 10.

Configuration of Display Device

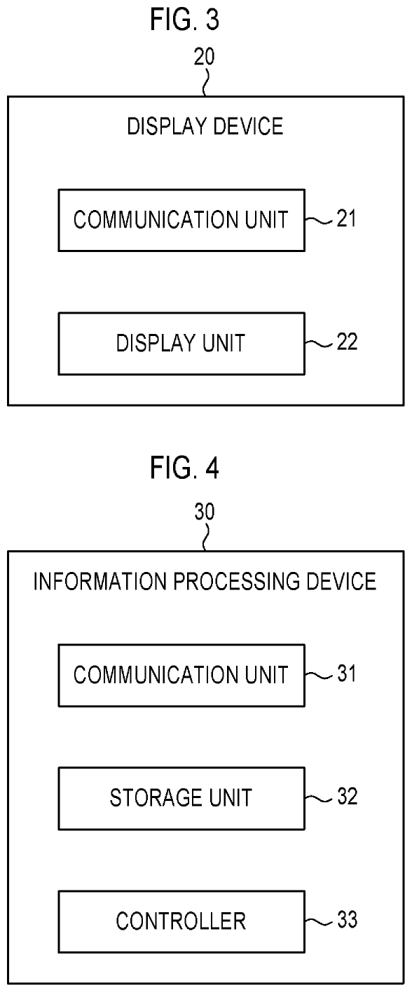

As shown in FIG. 3, the display device 20 includes a communication unit 21 and a display unit 22.

The communication unit 21 includes one or more communication interfaces connected to the network 40. The communication interface corresponds to, for example, a mobile communication standard, a wired local area network (LAN) standard, or a wireless LAN standard but is not limited to these and may correspond to any communication standard.

The display unit 22 has one or more light sources. For example, the display unit 22 may have a plurality of light sources disposed on the road surface. In the above case, the display unit 22 is capable of displaying any image (for example, a line, a figure, or a text) on the road surface by controlling a lighting state of each light source in response to an instruction from the information processing device 30. Alternatively, the display unit 22 may have, for example, one or more projecting devices each including a light source. In the above case, the display unit 22 is capable of displaying any image on the road surface by controlling an image projected on the road surface and a position where the image is projected in response to the instruction from the information processing device 30.

Configuration of Information Processing Device

As shown in FIG. 4, the information processing device 30 includes a communication unit 31, a storage unit 32, and a controller 33.

The communication unit 31 includes one or more communication interfaces connected to the network 40. The communication interface corresponds to, for example, a mobile communication standard, a wired LAN standard, or a wireless LAN standard but is not limited to these and may correspond to any communication standard.

The storage unit 32 includes one or more memories. Each memory included in the storage unit 32 may function as, for example, a main storage device, an auxiliary storage device, or a cache memory. The storage unit 32 stores any information used for an operation of the information processing device 30, and any instructions used for an operation of the controller 33. For example, the storage unit 32 may store a system program, an application program, a database, or map information. The information stored in the storage unit 32 may be capable of updating with information acquired from the network 40 via, for example, the communication unit 31.

The controller 33 includes one or more processors, one or more programmable circuits, one or more dedicated circuits, or a combination thereof. The controller 33 controls the operation of the entire information processing device 30.

Operation Flow of Information Processing Device

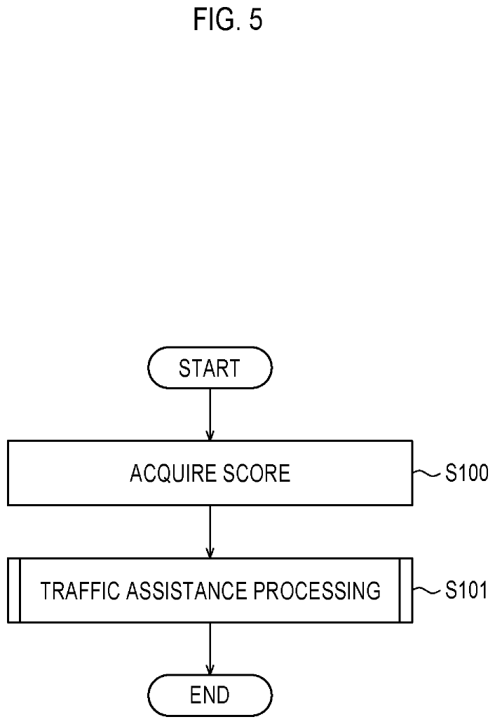

The operation flow of the information processing device 30 will be described with reference to FIG. 5.

Step S100: The controller 33 of the information processing device 30 acquires a score indicating a driving skill of a user who drives the vehicle 10.

In the present embodiment, the score is expressed by a numerical value (for example, an integer of 0 or more and 100 or less) or a grade (for example, “low”, “medium”, “high”), and the higher the numerical value or grade, the higher the driving skill. However, the content of the score is not limited to this example, and any content may be used for the score.

Any method can be employed for acquiring the score. For example, from the vehicle 10 or the terminal device, such as a smartphone used by the user via the communication unit 31 and the network 40, the controller 33 may receive a driving operation history of the user and calculate the score based on the driving operation history, or may directly receive the score. Typically, based on the driving operation history of the user, for example, when the average time desired at the time when the user parks the vehicle 10 is short, or when the average number of times of turning desired at the time when the user parks the vehicle 10 is small, the numerical value or grade of the score can be calculated to be high. However, the method of calculating the score is not limited to this example.

Step S101: The controller 33 executes the traffic assistance processing at the time when the vehicle 10 is parked based on the score acquired in step S100.

Specifically, the controller 33 determines whether or not the vehicle 10 is coming to a park by the user based on the information received from the vehicle 10 via the network 40. Any method can be employed for determining whether or not the vehicle 10 is coming to a park by the user. For example, a method of determining based on the vehicle information indicating the position, orientation, shift position of the vehicle 10 can be employed, but the method is not limited to this. Thereafter, when the fact that the vehicle 10 is coming to a park by the user is determined, the controller 33 executes the traffic assistance processing based on the score.

The traffic assistance processing is processing for assisting the traffic of the vehicle 10, or a person or other vehicles present in the vicinity of the vehicle 10. In the present embodiment, the traffic assistance processing includes at least one of four processing of first traffic assistance processing to fourth traffic assistance processing. Hereinafter, each of the first traffic assistance processing to the fourth traffic assistance processing will be specifically described.

First Traffic Assistance Processing

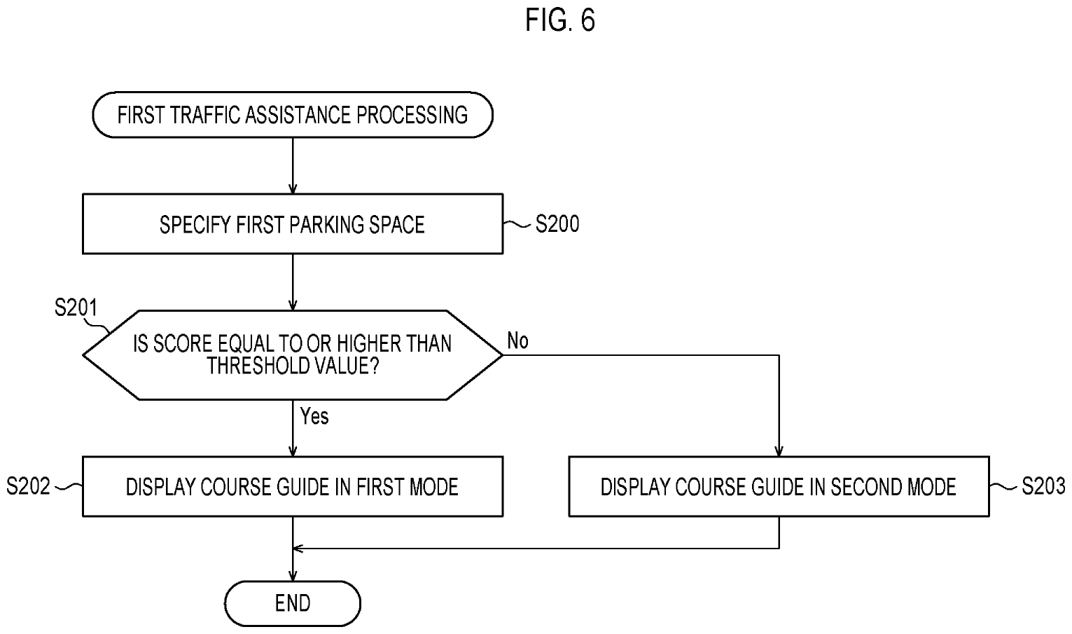

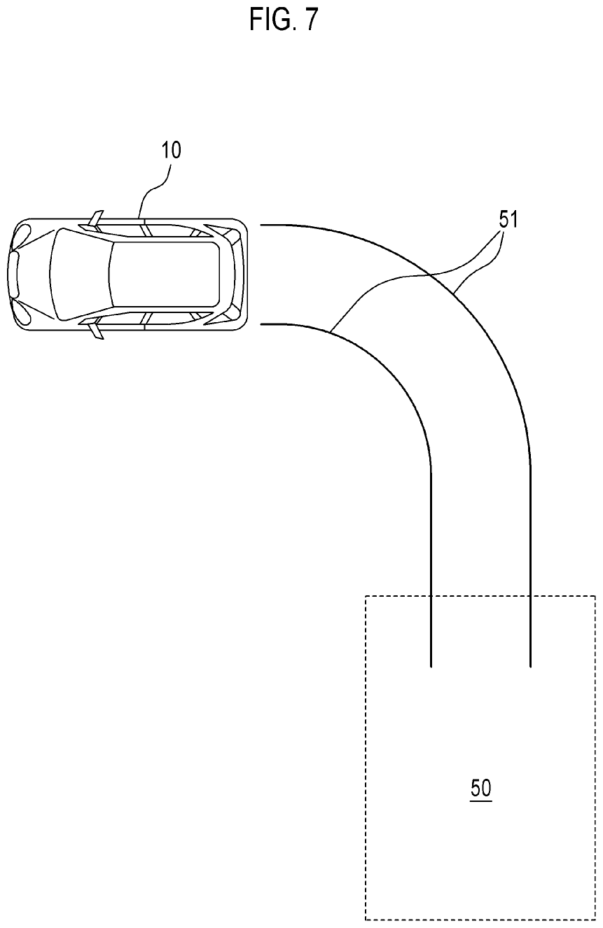

The first traffic assistance processing will be described with reference to FIGS. 6 and 7. As a general rule, the first traffic assistance processing is processing of displaying a course guide of the vehicle 10 on the road surface at the time when the user parks the vehicle 10 by using the display device 20.

Step S200: The controller 33 specifies a first parking space where the vehicle 10 is to be parked by the user.

Any method can be employed for specifying the first parking space. For example, the controller 33 receives vehicle speed information and position information of the vehicle 10, and a camera image in the vicinity of the vehicle 10 from the vehicle 10 via the communication unit 31 and the network 40. Based on the information received from vehicle 10, the controller 33 detects a parking space (for example, a parking space that exists within a predetermined distance from the vehicle 10) having a predetermined positional relationship with the vehicle 10 when the vehicle speed is less than a predetermined threshold value or becomes zero by using the camera image received from the vehicle 10 or the map information stored in advance in the storage unit 32 and specifies the parking space as the first parking space. Alternatively, the controller 33 may directly receive information indicating the first parking space selected by the user using the input unit 15 of the vehicle 10 from the vehicle 10 via the communication unit 31 and the network 40.

Step S201: The controller 33 determines whether or not the score acquired in step S100 described above is equal to or higher than a threshold value. The threshold value is, for example, a numerical value or a grade set in advance. When the controller 33 determines that the score is equal to or higher than the threshold value (step S201—Yes), the process proceeds to step S202. On the other hand, when the controller 33 determines that the score is less than the threshold value (step S201—No), the process proceeds to step S203.

Step S202: When the controller 33 determines that the score is equal to or higher than the threshold value in step S201 (step S201—Yes), the controller 33 causes the display device 20 to display the course guide in a first mode.

Specifically, the controller 33 specifies a course for the vehicle 10 to be parked in the first parking space based on the positional relationship between the vehicle 10 and the first parking space. The controller 33 transmits an instruction for displaying the course guide in the first mode to the display device 20 via the communication unit 31 and the network 40. The display unit 22 of the display device 20 displays the course guide in the first mode based on the instruction from the information processing device 30. The course guide is an image representing a specified course. For example, the course guide 51 shown in FIG. 7 is an image representing the course with two lines at the time when the vehicle 10 is parked in the first parking space 50 by moving the vehicle 10 backward without turning the vehicle 10. However, the course guide is not limited to the above described image and may be any image representing the course in which the vehicle 10 is parked in the first parking space. The first mode is, for example, a mode in which the course guide is being displayed with a predetermined brightness and color but is not limited to this. The controller 33 may update the display of the course guide in accordance with the movement of the vehicle 10.

Step S203: When the controller 33 determines that the score is less than the threshold value in step S201 (step S201—No), the controller 33 displays the course guide in a second mode that is different from the first mode.

Specifically, the controller 33 transmits an instruction for displaying the course guide in the second mode to the display device 20 via the communication unit 31 and the network 40. The display unit 22 of the display device 20 displays the course guide in the second mode based on the instruction from the information processing device 30. The second mode is a mode in which the course guide is displayed more conspicuous than in the first mode. Specifically, the second mode is, for example, a mode in which the course guide is displayed brighter than the first mode, a mode in which the course guide is blinked, or a mode in which the course guide is displayed in a color different from that in the first mode but is not limited to these. The controller 33 may update the display of the course guide in accordance with the movement of the vehicle 10.

As described above, according to the first traffic assistance processing, when the driving skill of the user who drives the vehicle 10 is relatively low, the display is performed in the second mode in which the course guide is displayed more conspicuous. Therefore, for example, for the user, the visibility of the course guide that can be visually recognized or visually recognized by the camera video of the image capturing unit 13 can be improved, and the load of the driving operation for parking can be reduced, for example. Since the driving skill of the user who drives the vehicle 10 can be recognized to be low for a person or another vehicle present in the vicinity of the vehicle 10, for example, by an action, such as waiting at a place away from the vehicle 10 until the parking of the vehicle 10 is completed, it is possible to improve the safety of the person or the other vehicle present in the vicinity of the vehicle 10 and reduce the psychological stress given to the user of the vehicle 10.

Second Traffic Assistance Processing

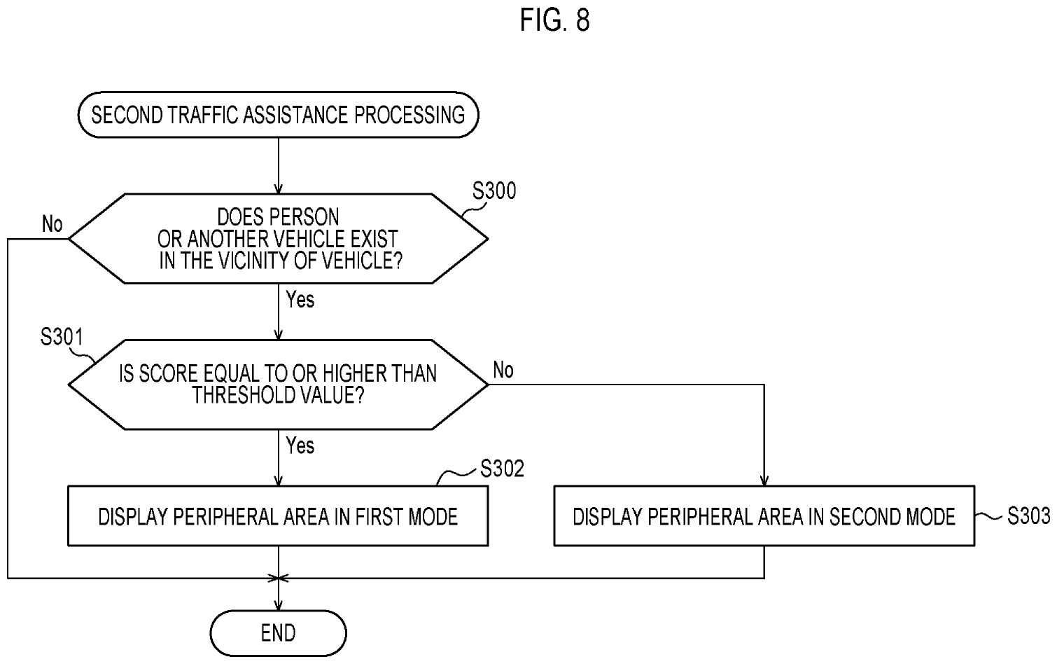

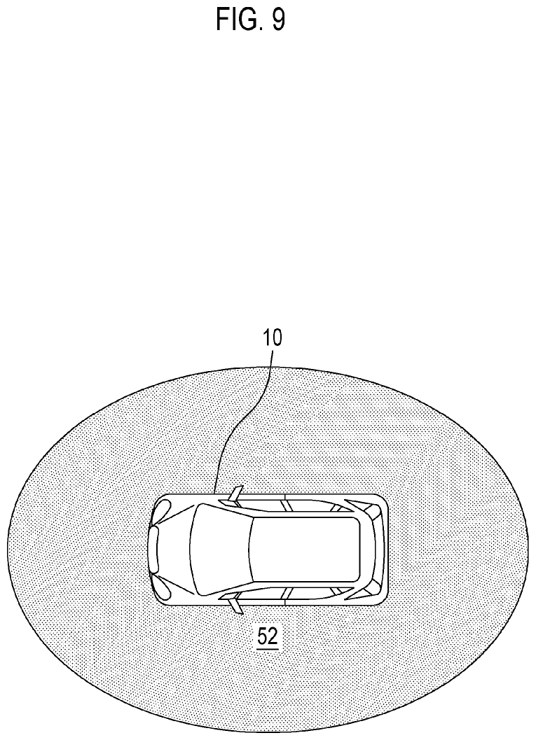

The second traffic assistance processing will be described with reference to FIGS. 8 and 9. As a general rule, the second traffic assistance processing is processing of displaying a peripheral area of the vehicle 10 on the road surface in a visually recognizable manner by using the display device 20.

Step S300: The controller 33 determines whether or not a person or another vehicle is present in the vicinity of the vehicle 10. When the controller 33 determines that a person or another vehicle is present (step S300—Yes), the process proceeds to step S301. On the other hand, when the controller 33 determines that a person or another vehicle is not present (step S300—No), the process is ended.

Step S301: When the controller 33 determines that a person or another vehicle is present in step S300 (step S300—Yes), the controller 33 determines whether or not the score acquired in step S100 described above is equal to or higher than the threshold value. The threshold value is, for example, a numerical value or a grade set in advance. The threshold value in step S301 may be the same as or different from the threshold value in step S201 of the first traffic assistance processing described above. When the controller 33 determines that the score is equal to or higher than the threshold value (step S301—Yes), the process proceeds to step S302. On the other hand, when the controller 33 determines that the score is less than the threshold value (step S301—No), the process proceeds to step S303.

Step S302: When the controller 33 determines that the score is equal to or higher than the threshold value in step S301 (step S301—Yes), the controller 33 causes the display device 20 to display the peripheral area of the vehicle 10 in a first mode.

Specifically, the controller 33 transmits an instruction for displaying the peripheral area of the vehicle 10 in the first mode to the display device 20 via the communication unit 31 and the network 40. The display unit 22 of the display device 20 displays the peripheral area of the vehicle 10 in the first mode based on the instruction from the information processing device 30. For example, the peripheral area 52 of the vehicle 10 shown in FIG. 9 is an elliptical-shaped area including the position of the vehicle 10. However, the displayed peripheral area of the vehicle 10 is not limited to an elliptical shape and may have any shape. For example, the peripheral area may be an area (for example, a substantially fan-shaped area extending toward each of the front of the vehicle 10 and behind the vehicle 10) on the road surface where the vehicle 10 can move for a predetermined time (for example, 0.5 seconds). The first mode is, for example, a mode in which the peripheral area of the vehicle 10 is being displayed with a predetermined brightness and color but is not limited to this. The controller 33 may update the display of the peripheral area of the vehicle 10 in accordance with the movement of the vehicle 10.

Step S303: When the controller 33 determines that the score is less than the threshold value in step S301 (step S301—No), the controller 33 displays the peripheral area of the vehicle 10 in a second mode that is different from the first mode.

Specifically, the controller 33 transmits an instruction for displaying the peripheral area of the vehicle 10 in the second mode to the display device 20 via the communication unit 31 and the network 40. The display unit 22 of the display device 20 displays the peripheral area of the vehicle 10 in the second mode based on the instruction from the information processing device 30. The second mode is a mode in which the peripheral area of the vehicle 10 is displayed more conspicuous than in the first mode. Specifically, the second mode is, for example, a mode in which the peripheral area of the vehicle 10 is displayed brighter than the first mode, a mode in which the peripheral area of the vehicle 10 is blinked, or a mode in which the peripheral area of the vehicle 10 is displayed in a color different from that in the first mode but is not limited to these. The controller 33 may update the display of the peripheral area of the vehicle 10 in accordance with the movement of the vehicle 10.

As described above, according to the second traffic assistance processing, when the driving skill of the user who drives the vehicle 10 is relatively low, the display is performed in the second mode in which the peripheral area of the vehicle 10 is displayed more conspicuous. Therefore, since the driving skill of the user who drives the vehicle 10 can be recognized to be low for a person or another vehicle present in the vicinity of the vehicle 10, for example, by an action, such as keeping the person and the other vehicle out of the peripheral area of the vehicle 10, it is possible to improve the safety of the person or the other vehicle present in the vicinity of the vehicle 10 and reduce the psychological stress given to the user of the vehicle 10.

Third Traffic Assistance Processing

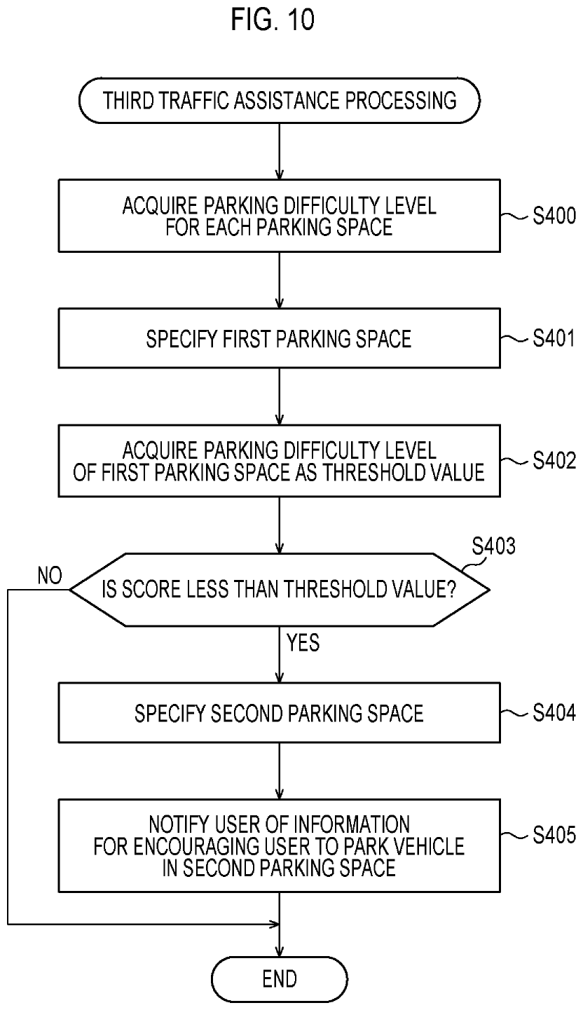

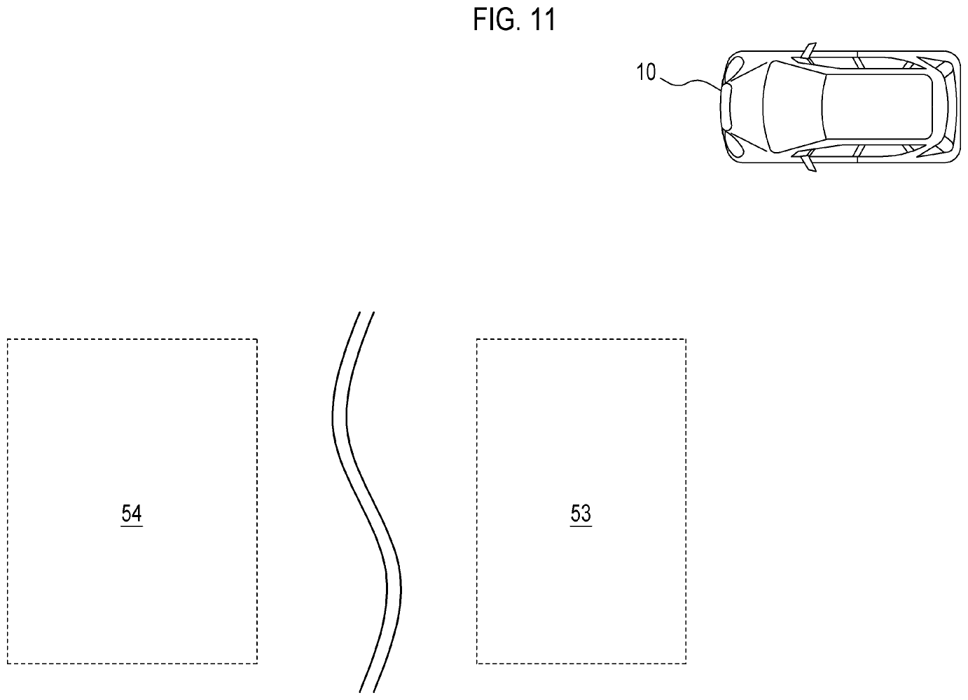

The third traffic assistance processing will be described with reference to FIGS. 10 and 11. As a general rule, the third traffic assistance processing is processing of notifying the user of information for encouraging the user to park the vehicle 10 in a second parking space where the parking difficulty level is lower than that of the first parking space, instead of the first parking space where the vehicle 10 is to be parked by the user.

Step S400: The controller 33 acquires parking difficulty levels for a plurality of parking spaces present in the vicinity of the vehicle 10. The parking difficulty level for each parking space is expressed by, for example, a numerical value or a grade.

Any method can be employed for acquiring the parking difficulty level of the parking space. For example, from a computer of a company operating a parking lot having a plurality of parking spaces via the communication unit 31 and the network 40, the controller 33 may receive images of the parking spaces and calculate the parking difficulty levels for the parking spaces based on the images, or may directly receive the parking difficulty levels for the parking spaces. Typically, when the parking space is narrow, or when many obstacles are present in the vicinity of the parking space (for example, pillars or other vehicles), the parking difficulty level of the parking space can be calculated to be high. However, the method of calculating the parking difficulty level is not limited to this example.

Step S401: The controller 33 specifies a first parking space where the vehicle 10 is to be parked by the user. For specifying the first parking space, the same method as in step S200 in the first traffic assistance processing described above can be employed.

Step S402: The controller 33 acquires the parking difficulty level of the first parking space specified in step S401 as a threshold value.

Step S403: The controller 33 determines whether or not the score acquired in step S100 described above is less than the threshold value acquired in step S402. When the controller 33 determines that the score is less than the threshold value (step S403—Yes), the process proceeds to step S404. On the other hand, when the controller 33 determines that the score is equal to or higher than the threshold value (step S403—No), the process is ended.

Step S404: When the controller 33 determines that the score is less than the threshold value in step S403 (step S403—Yes), the controller 33 specifies a second parking space where the parking difficulty level is lower than that of the first parking space among the parking spaces.

For example, in FIG. 11, another parking space is specified, which exists at a position farther from the vehicle 10 than the first parking space 53, is wider than the first parking space, and has a lower parking difficulty level, as the second parking space 54. When two or more parking spaces where the parking difficulty levels are lower than those of the first parking space exist, the controller 33 may specify one parking space located closest to the vehicle 10, specify one parking space where the parking difficulty level is the lowest, or specify one parking space where the parking difficulty level is closest to the score, as the second parking space among the two or more parking spaces.

Step S405: The controller 33 notifies the user of information for encouraging the user to park the vehicle 10 in the second parking space instead of the first parking space.

Specifically, the controller 33 transmits the information to the vehicle 10 via the communication unit 31 and the network 40. The vehicle 10 notifies the user of the information received from the information processing device 30 via the output unit 14. However, the information is not limited to the example in which the user is notified of the information via the vehicle 10, and the user may be notified of the information via a terminal device, such as a smartphone used by the user, for example.

As described above, according to the third traffic assistance processing, when the parking difficulty level of the first parking space is relatively high based on the driving skill of the user who drives the vehicle 10, the user is notified of the information for encouraging the user to park the vehicle 10 in the second parking space where the parking difficulty level is lower than that of the first parking space. Therefore, since the probability that the user parks the vehicle 10 in the second parking space where the parking difficulty level is relatively low, is improved, it is possible to improve the safety at the time when the user parks the vehicle 10.

Fourth Traffic Assistance Processing

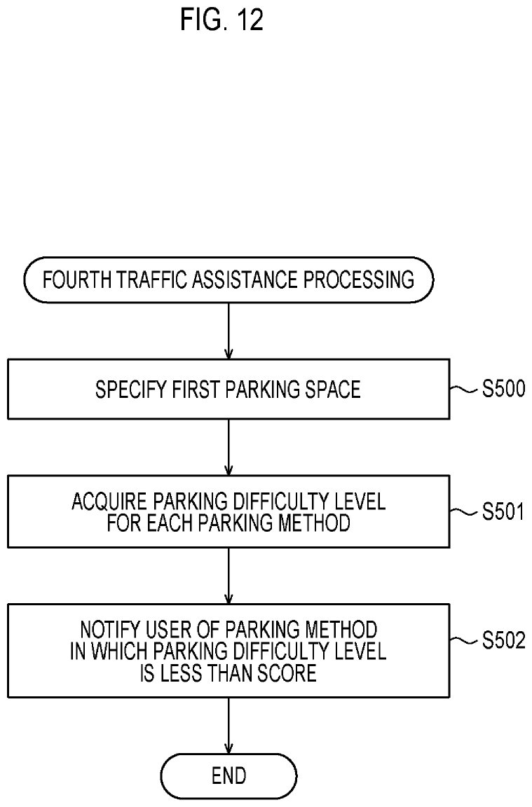

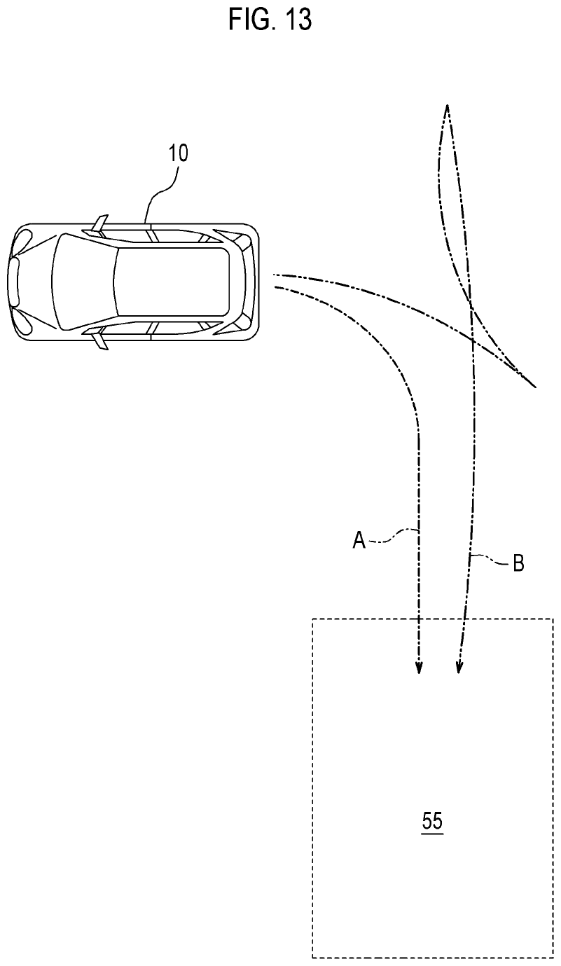

The fourth traffic assistance processing will be described with reference to FIGS. 12 and 13. As a general rule, the fourth traffic assistance processing is processing of notifying the user of a parking method in which the parking difficulty level is less than the score among a plurality of parking methods (for example, a plurality of parking methods each has the different number of times of turning) used for the first parking space where the vehicle 10 is to be parked by the user.

Step S500: The controller 33 specifies a first parking space where the vehicle 10 is to be parked by the user. For specifying the first parking space, the same method as in step S200 in the first traffic assistance processing described above can be employed.

Step S501: The controller 33 acquires the parking difficulty level of the first parking space for each parking method used for the first parking space.

In the present embodiment, each parking method used for the first parking space is distinguished by the number of times of turning at the time when the vehicle 10 is parked in the first parking space. For example, FIG. 13 shows two parking methods of a first parking method A in which the number of times of turning is 0 at the time when the vehicle 10 is parked by moving the vehicle 10 backward in the first parking space 55, and a second parking method B in which the number of times of turning is 1. The controller 33 may calculate the parking difficulty level of the first parking space based on the number of times of turning for each parking method used for the first parking space. Typically, when the parking method in which the number of times of turning is large, the parking difficulty level of the first parking space can be calculated to be low. However, the method of calculating the parking difficulty level is not limited to this example. For example, each parking method used for the first parking space may be distinguished by whether the vehicle 10 is parked forward or backward. Typically, when a backward parking method is used rather than a forward parking method, the parking difficulty level of the first parking space can be calculated to be high.

Step S502: The controller 33 notifies the user of the parking method in which the parking difficulty level is less than the score acquired in step S100 described above among the parking methods used for the first parking space.

Specifically, the controller 33 transmits information indicating the parking method in which the parking difficulty level is less than the score to the vehicle 10 via the communication unit 31 and the network 40. The vehicle 10 notifies the user of the information received from the information processing device 30 via the output unit 14. However, the information is not limited to the example in which the user is notified of the information via the vehicle 10, and the user may be notified of the information via a terminal device, such as a smartphone used by the user, for example. When two or more parking methods in which the parking difficulty level is less than the score exist, the controller 33 may transmit information indicating one parking method (for example, one parking method in which the number of times of turning is the smallest) in which the parking difficulty level is the highest among the two or more parking methods, to the vehicle 10.

As described above, according to the fourth traffic assistance processing, the user is notified of the parking method, in which the parking difficulty level of the first parking space is relatively low, based on the driving skill of the user who drives the vehicle 10. Therefore, since the probability that the user parks the vehicle 10 in the first parking space by using the parking method in which the parking difficulty level is relatively low, is improved, it is possible to improve the safety at the time when the user parks the vehicle 10.

As described above, the information processing device 30 according to the present embodiment acquires a score indicating a driving skill of a user who drives the vehicle 10. Thereafter, the information processing device 30 executes traffic assistance processing at the time when the vehicle 10 is parked based on the score.

According to the configuration as described above, the technology for assisting traffic at the time when a vehicle is parked is improved in that the traffic assistance processing can be executed according to a driving skill of a user who drives the vehicle 10.

Although the present disclosure has been described based on the drawings and examples, it should be noted that those skilled in the art may make various modifications and changes based on the present disclosure. Therefore, these modifications and changes are within the scope of the present disclosure. For example, the functions included in each component or each step can be rearranged so as not to be logically inconsistent, and a plurality of components or steps can be combined or divided into one.

For example, the vehicle 10 may execute a part or all of the operations executed by the information processing device 30 in the above-described embodiment. The operations executed by the information processing device 30 may be distributed and executed by a plurality of computers capable of communicating with each other.

Further, in the above-described embodiment, an exemplary embodiment has been described in which the information processing device 30 displays the course guide of the vehicle 10 on the road surface by using the display device 20 when the first traffic assistance processing is executed. However, an exemplary embodiment can be also described in which the information processing device 30 displays the course guide of the vehicle 10 on a screen of a display by using the display included in the output unit 14 of the vehicle 10.

Further, for example, an embodiment in which a general-purpose computer is caused to function as the information processing device 30 according to the above-described embodiment is also possible. Specifically, a program, in which the processing content for implementing each function of the information processing device 30 according to the above-described embodiment is written, is stored in a memory of a computer, and the program is read and executed by a processor of the computer. Therefore, the disclosure according to the present embodiment can also be achieved as a program that can be executed by a processor or a non-transitory computer-readable medium that stores the program.

What is claimed is:

1. A method executed by an information processing device, the method comprising:
acquiring a score indicating a driving skill of a user who drives a vehicle; and
executing traffic assistance processing based on the score, at a time when the vehicle is parked.

2. The method according to claim 1, wherein:
the traffic assistance processing includes first traffic assistance processing of displaying a course guide of the vehicle on a road surface by using a display device at a time when the user parks the vehicle;
the course guide is displayed in a first mode when the score is equal to or higher than a threshold value; and
the course guide is displayed in a second mode, in which the course guide is displayed more conspicuous than in the first mode, when the score is less than the threshold value.

3. The method according to claim 1, wherein:
the traffic assistance processing includes second traffic assistance processing of displaying a peripheral area of the vehicle on a road surface by using a display device in a visually recognizable manner;
the peripheral area of the vehicle is displayed in a first mode when the score is equal to or higher than a threshold value; and
the peripheral area of the vehicle is displayed in a second mode, in which the peripheral area is displayed more conspicuous than in the first mode, when the score is less than the threshold value.

4. The method according to claim 3, further comprising determining whether or not a person or another vehicle is present in a vicinity of the vehicle,
wherein the information processing device executes the second traffic assistance processing when the information processing device determines that the person or the other vehicle is present in a vicinity of the vehicle.

5. The method according to claim 1, further comprising:
specifying a first parking space where the vehicle is to be parked by the user;
acquiring a first parking difficulty level of the first parking space as a threshold value; and
specifying a second parking space having a second parking difficulty level which is lower than the first parking difficulty level of the first parking space, when the score is less than the threshold value,
wherein the information processing device executes, as the traffic assistance processing, third traffic assistance processing of notifying the user of information for encouraging the user to park the vehicle in the second parking space instead of the first parking space, when the score is less than the threshold value.

6. The method according to claim 1, further comprising:
specifying a first parking space where the vehicle is to be parked by the user; and
acquiring a parking difficulty level of the first parking space for each of a plurality of parking methods used for the first parking space,
wherein the information processing device executes, as the traffic assistance processing, fourth traffic assistance processing of notifying the user of the parking method in which the parking difficulty level is less than the score among the parking methods used for the first parking space.

7. The method according to claim 6, wherein when two or more parking methods in which the parking difficulty level is less than the score exist, the user is notified of one parking method in which the parking difficulty level is highest among the two or more parking methods.

8. An information processing device comprising a controller,
wherein the controller is configured to
acquire a score indicating a driving skill of a user who drives a vehicle, and
execute traffic assistance processing based on the score, at a time when the vehicle is parked.

9. The information processing device according to claim 8, wherein:
the traffic assistance processing includes first traffic assistance processing of displaying a course guide of the vehicle on a road surface by using a display device at a time when the user parks the vehicle; and
the controller is configured to
display the course guide in a first mode when the score is equal to or higher than a threshold value, and
display the course guide in a second mode, in which the course guide is displayed more conspicuous than in the first mode, when the score is less than the threshold value.

10. The information processing device according to claim 8, wherein:
the traffic assistance processing includes second traffic assistance processing of displaying a peripheral area of the vehicle on a road surface by using a display device in a visually recognizable manner; and
the controller is configured to
display the peripheral area of the vehicle in a first mode when the score is equal to or higher than a threshold value, and
display the peripheral area of the vehicle in a second mode, in which the peripheral area is displayed more conspicuous than in the first mode, when the score is less than the threshold value.

11. The information processing device according to claim 10, wherein the controller is configured to
determine whether or not a person or another vehicle is present in a vicinity of the vehicle, and
execute the second traffic assistance processing when the controller determines that the person or the other vehicle is present in a vicinity of the vehicle.

12. The information processing device according to claim 8, wherein the controller is configured to
specify a first parking space where the vehicle is to be parked by the user,
acquire a first parking difficulty level of the first parking space as a threshold value,
specify a second parking space having a second parking difficulty level which is lower than the first parking difficulty level of the first parking space, when the score is less than the threshold value, and
execute, as the traffic assistance processing, third traffic assistance processing of notifying the user of information for encouraging the user to park the vehicle in the second parking space instead of the first parking space, when the score is less than the threshold value.

13. The information processing device according to claim 8, wherein the controller is configured to
specify a first parking space where the vehicle is to be parked by the user,
acquire a parking difficulty level of the first parking space for each of a plurality of parking methods used for the first parking space, and
execute, as the traffic assistance processing, fourth traffic assistance processing of notifying the user of the parking method in which the parking difficulty level is less than the score among the parking methods used for the first parking space.

14. The information processing device according to claim 13, wherein when two or more parking methods in which the parking difficulty level is less than the score exist, the user is notified of one parking method in which the parking difficulty level is highest among the two or more parking methods.

15. A non-transitory storage medium storing instructions that are executable by one or more processors and that cause the one or more processors to perform functions comprising:
acquiring a score indicating a driving skill of a user who drives a vehicle; and
executing traffic assistance processing based on the score, at a time when the vehicle is parked.

16. The non-transitory storage medium according to claim 15, wherein:
the traffic assistance processing includes first traffic assistance processing of displaying a course guide of the vehicle on a road surface by using a display device at a time when the user parks the vehicle; and
the one or more processors is configured to
display the course guide in a first mode when the score is equal to or higher than a threshold value, and
display the course guide in a second mode, in which the course guide is displayed more conspicuous than in the first mode, when the score is less than the threshold value.

17. The non-transitory storage medium according to claim 15, wherein:
the traffic assistance processing includes second traffic assistance processing of displaying a peripheral area of the vehicle on a road surface by using a display device in a visually recognizable manner; and
the one or more processors is configured to
display the peripheral area of the vehicle in a first mode when the score is equal to or higher than a threshold value, and
display the peripheral area of the vehicle in a second mode, in which the peripheral area is displayed more conspicuous than in the first mode, when the score is less than the threshold value.

18. The non-transitory storage medium according to claim 17, wherein:
the function further includes determining whether or not a person or another vehicle is present in a vicinity of the vehicle; and
the one or more processors execute the second traffic assistance processing when the one or more processors determine that the person or the other vehicle is present in a vicinity of the vehicle.

19. The non-transitory storage medium according to claim 15, wherein the function further includes:
specifying a first parking space where the vehicle is to be parked by the user;
acquiring a first parking difficulty level of the first parking space as a threshold value; and
specifying a second parking space having a second parking difficulty level which is lower than the first parking difficulty level of the first parking space, when the score is less than the threshold value, and
the one or more processors execute, as the traffic assistance processing, third traffic assistance processing of notifying the user of information for encouraging the user to park the vehicle in the second parking space instead of the first parking space, when the score is less than the threshold value.

20. The non-transitory storage medium according to claim 15, wherein the function further includes:
specifying a first parking space where the vehicle is to be parked by the user; and
acquiring a parking difficulty level of the first parking space for each of a plurality of parking methods used for the first parking space, and
the one or more processors execute, as the traffic assistance processing, fourth traffic assistance processing of notifying the user of the parking method in which the parking difficulty level is less than the score among the parking methods used for the first parking space.
